(19) United States
(12) Patent Application Publication
(10) Pub. No.: US 2020/0172371 A1
(43) Pub. Date: Jun. 4, 2020

(54) METHOD, SYSTEM AND COMPUTER READABLE STORAGE MEDIUM FOR CONTROLLING OPERATION OF AN ELEVATOR

(71) Applicant: Otis Elevator Company, Farmington, CT (US)

(72) Inventors: Jinlei Ding, Shanghai (CN); Yuan Yuan, Shanghai (CN); Kai Zhang, Shanghai (CN); Xing Cai, Shanghai (CN)

(21) Appl. No.: 16/697,619

(22) Filed: Nov. 27, 2019

(30) Foreign Application Priority Data
Nov. 29, 2018 (CN) 201811443986.4

(51) Int. Cl. B66B 1/24; B66B 5/00; B66B 1/34; G07C 1/04

(52) U.S. Cl. CPC B66B 1/2416; B66B 5/0031; B66B 1/3461; B66B 2201/402; G07C 1/04; B66B 2201/235; B66B 5/0012

(57) ABSTRACT

A method, system, and computer readable storage medium for controlling elevator operation. More specifically, the embodiments of the present invention relate to controlling elevator operation by means of media information. In accordance with one or more embodiments of the present invention, there is provided a computer implemented method for controlling elevator operation. The method comprises receiving and storing media information over a network; obtaining an indication of an event that has occurred or is about to occur based on the media information, the indication including date, time, and location information of the event; and determining one or more buildings associated with the event based on the indication. The method generates a command for controlling the operation of one or more elevators in the one or more buildings at least partly based on the indication.

### FOREIGN PRIORITY

This application claims priority to Chinese Patent Application No. 201811443986.4, filed Nov. 29, 2018, and all the benefits accruing therefrom under 35 U.S.C. § 119, the contents of which in its entirety are herein incorporated by reference.

### FIELD OF THE INVENTION

The embodiments of the present invention relate to a method, system, and computer readable storage medium for controlling elevator operation. More specifically, the embodiments of the present invention relate to controlling elevator operation by means of media information.

### BACKGROUND ART

Elevator systems located in a building assign passengers to specific cars according to destination floors input by passengers through buttons in a lobby or on various floors. Some elevator systems dispatch elevators by using computer algorithms to reduce power usage of elevator systems and waiting time of passengers. Some elevator systems estimate peak periods of passenger flow, and set corresponding upward peak periods and downward peak periods. Some other elevator systems allow passengers to request destination floors in advance through various communication devices.

### SUMMARY OF THE INVENTION

In accordance with one or more embodiments of the present invention, there is provided a computer implemented method for controlling elevator operation. The method comprises receiving and storing media information over a network; obtaining an indication of an event that has occurred or is about to occur based on the media information, the indication including the date, time, and location information of the event; and determining one or more buildings associated with the event based on the indication. The method generates a command for controlling the operation of one or more elevators in the one or more buildings, at least partly based on the indication.

In accordance with one or more embodiments of the invention, there is provided a system for controlling elevator operation, which comprises a computer processor, a computer readable storage medium, and program instructions stored on the computer readable storage medium. The program instructions when executed by the processor perform the following steps: receiving and storing media information over a network; obtaining an indication of an event that has occurred or is about to occur based on the media information, the indication including the date, time, and location information of the event; determining one or more buildings associated with the event based on the indication; and generating a command for controlling the operation of one or more elevators in the one or more buildings, at least partly based on the indication.

In accordance with one or more embodiments of the present invention, there is provided a computer readable storage medium having instructions thereon, wherein the instructions when executed cause a computing device to perform the steps of the method for controlling elevator operation.

In accordance with one or more embodiments of the invention, there is provided a computing device. The computing device may comprise components corresponding to the procedure for carrying out the method for controlling elevator operation as described in other embodiments of the present invention.

In an alternative embodiment, one or more buildings associated with an event are determined based on location information of the event.

In an alternative embodiment, a command guides car(s) of the one or more elevators to a specific floor.

In an alternative embodiment, a command sets the operating state of one or more elevators as: start operation, stop operation, high speed mode, low speed mode, or a mode for serving a specific floor.

In an alternative embodiment, media information is received from a social media server over a network and stored.

In an alternative embodiment, media information includes traffic information, activity information, or alert information.

In an alternative embodiment, a command for controlling the operation of one or more elevators is generated at least partly based on the indication and historical data associated with the event.

In an alternative embodiment, a command for controlling the operation of one or more elevators is generated at least partly based on the indication and parameters associated with one or more elevators.

In accordance with the embodiments of the present invention, there is provided a method, system, and computer readable storage medium for controlling elevator operation by means of media information. In various embodiments of the present invention, it is proposed that media information should be utilized to sense conditions in the vicinity of elevators or buildings so as to maintain or improve elevator user experience, reduce elevator energy consumption, or lower elevator maintenance costs. In other embodiments, based on one or more of an event that has occurred or is about to occur, historical data associated with the event, and parameters associated with elevators (for example, historical data of elevator operation or sensor data), crowd movement information affected by the event is determined, associated with a specific date, time period, and location, and employed for elevator scheduling.

### BRIEF DESCRIPTION OF THE DRAWINGS

The aforementioned features and other features, and advantages of various embodiments of the present invention will be apparent from the following detailed description in conjugation with the drawings, wherein like numerals denote like elements.

FIG. 1 is a schematic diagram showing computing system 10 which controls elevator operation in accordance with various embodiments of the present invention.

FIG. 2 is a schematic diagram showing elevator operation server 20 which controls elevator operation in accordance with various embodiments of the present invention.

FIG. 3 is a flow chart showing elevator operation control in accordance with various embodiments of the present invention.

FIG. 4 illustrates an exemplary computing device suitable for use in the present invention in accordance with various embodiments.

### DETAILED DESCRIPTION OF THE INVENTION

In the following description, numerous specific details are described to provide a thorough understanding of exemplary embodiments of the present invention. However, it is known to one of ordinary skill in the art that the exemplary embodiments disclosed herein may also be carried out without these details. In other cases, well-known methods, procedures and components are not elaborated lest the exemplary embodiments should be rendered ambiguous. The following description uses such expressions as “in the embodiments” or “in the examples” which respectively indicate one or more of the same or different embodiments. The terminology used herein is chosen to better explain the principles of various embodiments, the practical application or technical improvement, or to enable one of ordinary skill in the art to understand and carry out the embodiments disclosed herein.

One or more embodiments of the present invention may be a computing system, method and computer program product. The computer program product may comprise a computer readable storage medium (or medium) on which computer readable program instructions are stored to cause a processor to implement various embodiments of the present invention.

In most examples, the term “elevator” is used in the text. However, it should be understood that the principles and examples with respect to elevators described herein may also be applied to other passenger transportation devices, such as escalators and moving walkways.

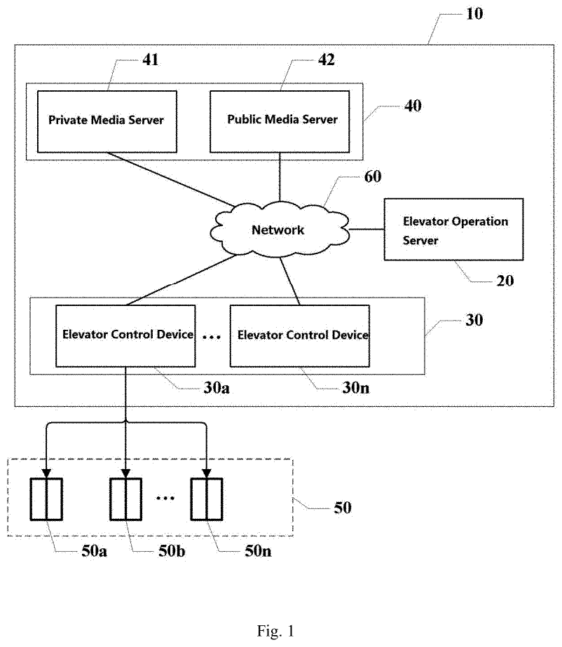

FIG. 1 is a schematic diagram showing computing system 10 which controls elevator operation in accordance with various embodiments of the present invention.

Computing system 10 includes elevator operation server 20, elevator control device 30, media server 40, and network 60, wherein elevator operation server 20, elevator control device 30, and media server 40 are communicated in a wired or wireless manner over network 60.

Network 60 may be a local area network (LAN), a wide area network (WAN), or a mobile communication network. The mobile communication network may be, for example, Global System for Mobile Communications (GSM), General Packet Radio Service (GPRS), Universal Mobile Telecommunications System (UMTS), High Speed Packet Access (HSPA), Evolved HSPA (E-HSPA) or Long Term Evolution (LTE) network.

Elevator operation server 20 may receive and store media information from media server 40 over network 60, receive parameters associated with elevators from elevator control device 30, and send to elevator control device 30 a command for controlling the operation of one or more elevators in one or more buildings.

Elevator control device 30 may be a plurality of elevator control devices 30a . . . 30n. Elevator control device 30a may be coupled to building 50, and control the operation of one or more of elevators 50a . . . 50n, according to a command from elevator operation server 20.

Media server 40 may include a private media server 41 and a public media server 42. Media server 40 may communicate with elevator operation server 20 in accordance with a specific data exchange interface protocol. Media server 40 may be a social media server.

The composition of computing system 10 will be described in greater detail below.

Elevator operation server 20 is a computing system capable of processing program instructions and receiving and transmitting data. For example, elevator operation server 20 may be a personal computer (PC), a mobile phone, a tablet, or a computing system that uses a plurality of computing devices as a server, such as a cloud server.

In some embodiments, elevator operation server 20 may receive and store media information from private media server 41 and/or public media server 42 over network 60, and obtain an indication of an event that has occurred or is about to occur based on media information, the indication including the date, time, and location information of the event. Moreover, elevator operation server 20 may determine one or more buildings associated with the event based on the indication, and generate a command for controlling the operation of one or more elevators in one or more buildings at least partly based on the indication.

In some embodiments, historical data associated with the event are considered. Elevator operation server 20 obtains an indication of an event that has occurred or is about to occur based on media information, determines one or more buildings associated with the event based on the indication, and generates a command for controlling the operation of one or more elevators in one or more buildings at least partly based on the indication and historical data associated with the event.

In some embodiments, parameters associated with the elevator are considered. Elevator operation server 20 may generate a command for controlling elevator operation based on parameters associated with the elevator which are collected from an elevator control device, thereby collectively managing the operation of one or more elevators located in the same or different buildings.

In some embodiments, media information and parameters associated with the elevator are considered at the same time. Elevator operation server 20 obtains an indication of an event that has occurred or is about to occur based on media information, determines one or more buildings associated with the event based on the indication, and generates a command for controlling the operation of one or more elevators in one or more buildings at least partly based on the indication and parameters associated with the elevator which are collected from an elevator control device.

Elevator control device 30 includes a computing system capable of processing program instructions and receiving and transmitting data. Elevator control device 30 controls the operation of one or more elevators located in building 20, according to a command from elevator operation server 20.

In some embodiments, elevator control device 30 may also include a drive train, such as a rope/chain system driven by an electric motor and gears. In some embodiments, elevator control device 30 may also include a rail assembly capable of controlling car movement. When a car reaches the desired destination, elevator control device 30 may use a brake to hold the car in place. In some embodiments, elevator control device 30 may further include sensors positioned on the car, within the car, and/or within the elevator shaft where the elevator car travels. The sensors may be any device capable of detecting an event or change in the environment and providing a corresponding output. Illustratively, the sensor may be an optical sensor, a facial recognition sensor, a weight sensor, a near field communication (NFC) device, a radio frequency identification (RFID) tag, an accelerometer, and the like. Elevator control device 30, through various sensors, may measure one or more of the following elevator parameters: travel time of the car between the floors, time when the elevator door is opened/closed, a period during which the elevator door remains open/closed, travel speed of the car, the number of people waiting to enter the elevator during a specific time period, the number of people in the building lobby during a specific time period, the number of people on a specific floor of the building during a specific time period, and so on. In some embodiments, elevator control device 30 may also store historical data of elevator operation, such as peak period, elevator operation mode when a particular event occurs, and other data reflecting the elevator operating state and operating efficiency under certain conditions. The historical data of elevator operation may also include the location and operating state of the elevator car during a particular time in the past.

Elevator control device 30 may execute the command from elevator operation server 20 to perform one or more of the following control operations: starting or stopping elevator operation, controlling the closing/opening of the door of the elevator car, and guiding the elevator car to a specific floor, controlling the speed at which the elevator car moves between the floors within a building, switching elevator operation to different operation modes, such as high speed mode, low speed mode, or a mode for serving a specific floor. Elevator control device 30 may also execute the command for controlling elevator operation in accordance with a predefined scheduling scheme.

Elevator control device 30 may send parameters associated with the elevator such as the elevator identification, current car load, current car location, position of the building where the elevator is located, and historical data of elevator operation to elevator operation server 20 over network 60.

It can be understood that in different embodiments, there may be one or more elevator control devices 30, and a plurality of elevators may be located in the same building, or may be arranged separately in different buildings. A plurality of buildings may have geographically similar or different locations.

Media server 40 is a computing system capable of processing program instructions and receiving and transmitting data. For example, the media server may be a personal computer (PC), a mobile phone, a tablet, or a computing system that uses a plurality of computing devices as a server (e.g., a cloud server). The media server may communicate with elevator operation server 20 in accordance with a specific data exchange interface protocol. Media information may include traffic information, activity information, or alert information. The traffic information may indicate the date, time, and location information of a traffic condition such as subway outage or traffic line congestion. The activity information may indicate the date, time, and location of an activity which is, for example, movie show time, time for holding a conference, and opening hours of exhibition center. The alert information may be, for example, fire alarm information.

In some embodiments, media server 40 may be a public media server or a private media server. The media server may provide a variety of information via web pages, or computer application interfaces on PC/mobile communication devices (e.g., data exchange interfaces for various social platform accounts). In some embodiments, media information provided by media server 40 may explicitly include the date, time, and location information of an event that has occurred or is about to occur.

The following description relates to interaction between elevator operation server 20 and media server 40 and elevator control device 30.

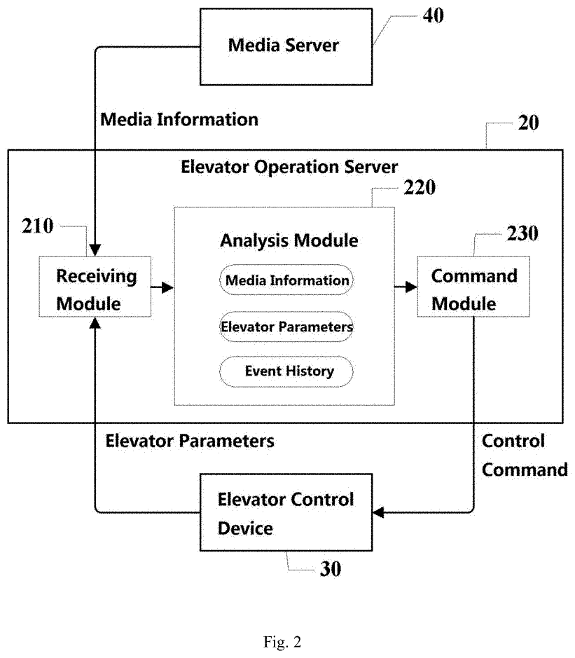

FIG. 2 is a schematic diagram showing elevator operation server 20 which controls elevator operation in accordance with various embodiments of the present invention. The embodiment shows the composition of elevator operation server 20, and interaction between elevator operation server 20 and media server 40 and elevator control device 30, wherein data flow is exemplarily depicted. Elevator operation server 20 may include receiving module 210, analysis module 220, and command module 230. Receiving module 210, for example, receives and stores media information from media server 40 over a network, and receives and stores elevator parameters from elevator control device 30. Analysis module 220 forms an elevator scheduling scheme based on the received media information and elevator parameters. In the command module, the scheduling scheme to be executed is transmitted in the form of a control command to elevator control device 30.

Some embodiments of the present invention are described below, wherein analysis module 220 obtains an indication of an event that has occurred or is about to occur based on the received media information, the indication including the date, time, and location information of the event.

In some examples, elevator operation server 20 performs elevator scheduling based on media information. Elevator operation server 20 may obtain media information through a HTTP protocol according to the URL list provided by the media server. It is known to one of ordinary skill in the art that elevator operation server 20 may communicate with media server 40 in accordance with a specific data exchange interface protocol, and obtain media data from the corresponding data interface.

In some cases, media information may explicitly include the date, time, and location information of an event that has occurred or is about to occur.

In some other cases, elevator operation server 20 may analyze media information through Natural Language Processing (NLP) technology to extract the date, time, and location of an event that has occurred or is about to occur. In these cases, elevator operation server 20 reads original data from the media server, performs data preprocessing through data cleaning, data slicing, and word segmentation, and then extracts information through part-of-speech tagging, and identification of named entities and relationships, and finally obtains information such as the date, time, and location of an event that has occurred or is about to occur. One of ordinary skill in the art may understand that various specific NLP algorithms may also be used to identify key information of a particular event, for example, information such as the date, time, and location of an event that has occurred or is about to occur, from media information

In some examples, elevator operation server 20 may then determine one or more buildings associated with an event based on key information of the event. For example, elevator operation server 20 may determine one or more buildings associated with an event based on location information of the event. In this example, elevator operation server 20 may store geographic location information of one or more buildings or obtain geographic location information of one or more buildings from elevator control device 30. In some cases, elevator operation server 20 may take buildings within a specific range of the location of the event as one or more buildings associated with the event, for example, buildings near a location where a traffic condition occurs, or buildings near a station next to the one where subway failure occurs. In some cases, elevator operation server 20 may determine buildings associated with an event based on the nature of the event, for example, buildings where an activity, a meeting, or an exhibition is to be held.

After determining the buildings associated with the event, elevator operation server 20 may generate a demand for controlling the operation of one or more elevators in one or more buildings at least partly based on the indication of the event extracted from media information. In some cases, elevator operation server 20 may determine buildings in the vicinity of an event based on the building where the event (e.g., a fire alarm) occurs. In some other cases, elevator operation server 20 may determine specific one or more of the floors within a building where an event that has occurred or is about to occur based on the content of the event other than attributes such as the date, time, and location of the event. In various embodiments of the present invention, elevator operation server 20 actively adjusts the operation mode of the elevator and the location of the car based on information from the media.

Some scenarios of performing elevator scheduling based on media information will be described as follows.

In the first scenario, receiving module 210 receives and stores traffic information from media server 40 over a network. The traffic information may indicate the date, time, and location information of a traffic condition which is, for example, subway outage, traffic line congestion, and the like. Analysis module 220 determines one or more buildings associated with the traffic condition based on the date, time, and location information of the traffic condition. Analysis module 220 may match the location information of the traffic condition with the building location information to determine one or more buildings associated with the traffic condition. Analysis module 220 generates a command for controlling the operation of one or more elevators in one or more buildings at least partly based on the date, time, and location information of the traffic condition. Command module 230 transmits the command generated by analysis module 220 to an elevator control device via the network. In one specific application, elevator operation server 20 determines that one or more office buildings in the vicinity of stations B and C which are two stations next to station A will have a delayed morning rush hour based on the information of subway outage at station A during the morning rush hour. Elevator operation server 20 may accordingly send a command to extend/delay the morning rush hour operation mode to elevator control device 30. In this application, elevator operating server 20 dispatches the elevator based on an event that has occurred. It can be understood that in other applications, elevator operating server 20 may dispatch elevators based on an event that is to occur.

In the second scenario, receiving module 210 receives and stores activity information from media server 40 over a network. The activity information may indicate the date, time, and location information of an activity which is, for example, movie show time, time for holding a conference, and opening hours of exhibition center. Analysis module 220 determines one or more buildings associated with the activity based on the date, time, and location information of the activity. Analysis module 220 may match the location information of the activity with the building location information to determine one or more buildings associated with the activity. Analysis module 220 generates a command for controlling the operation of one or more elevators in one or more buildings at least partly based on the date, time, and location information of the activity. Command module 230 transmits the command generated by analysis module 220 to an elevator control device via the network. In one specific application, elevator operation server 20 determines the time when a movie starts or ends based on movie show information issued by a movie theater in a building. Elevator operation server 20 may accordingly send a command to elevator control device 30 such that the elevator operates in a high speed mode at the time approximate to the start and end of the movie. In another specific application, elevator operation server 20, based on official data from social media, obtains the date, time, and location information of an exhibition project, and relevant information such as the number of visitors entering the exhibition hall and the floor of the building where the exhibition hall is located. Elevator operation server 20 may accordingly send a command to elevator control device 30 such that one or more elevator cars is/are directed to a specific floor, or one or more elevators just serve(s) specific one or more floors to lighten heavy traffic.

In the third scenario, receiving module 210 receives and stores alert information from media server 40 over a network. The alert message may indicate the date, time, and location information of an accident. The alert may be, for example, fire alarm information. In one specific application, elevator operation server 20 determines the location of the building giving a fire alarm and the location of adjacent buildings based on the fire alarm information posted on public media or based on information posted on social media by a person who discovered the fire alarm. Elevator operation server 20 may accordingly send a command to elevator control device 30 such that one or more elevators in adjacent buildings enter an OE0 emergency dispatch mode to evacuate personnel therein in the shortest time possible.

Some embodiments of the present invention will be described below, wherein analysis module 220 determines an elevator scheduling scheme based on one or more of media information, elevator parameters, and event history.

In some examples, elevator operating server 20 generates a command for controlling the operation of one or more elevators in one or more buildings at least partly based on the indication and historical data associated with the event. In some other examples, elevator operating server 20 may generate a command for controlling the operation of one or more elevators in one or more buildings at least partly based on the indication and the parameters associated with the elevator which are collected from the elevator control device. In some other examples, elevator operation server 20 may generate a command for controlling elevator operation based on the parameters associated with the elevator that are collected from the elevator control device, thereby collectively managing the operation of one or more elevators located in the same or different buildings.

In these embodiments, elevator operation server 20 may generate a more efficient control command in conjunction with the parameters associated with the elevator and/or historical data associated with the event, in addition to media information. In one example, apart from key information of an event extracted from media information, elevator operation server 20 also obtains pedestrian flow by surveillance cameras in the lobby of a building from elevator control device 30, to determine whether the event affects the normal pedestrian flow in the building. In one example, apart from key information of an event extracted from media information, elevator operation server 20 may store or obtain historical data regarding various events and elevator operation. In the case of occurrence of the above-mentioned event or the like, elevator operation server 20, based on a previous operation mode associated with the event or historical data of elevator operation (for example, waiting time, or the number of people in the car), may adjust the current elevator operation mode, for example, speed up or slow down the elevator operation. Parameters associated with the elevator and historical data of various events that are collected from the elevator control device may help to further improve efficiency in elevator operation.

In some embodiments, external data of an elevator system, particularly information of an event outside a building obtained in accordance with the embodiments of the present invention, may serve as a input for simulation, which in combination with historical data of elevator operation are used for simulation analysis with digital twin (DT) technology. Digital twin DT is digital copying of a process and/or system of physical entities, also known as “digital mirroring” or “digital mapping”; the corresponding DT model is a digital model which may obtain and analyze real-time information of a physical model by multiple means (for example, obtain real-time information by components such as sensors in physical entities), and exhibit various elements in the physical model and real-time dynamic operation in an entire life cycle, thereby fulfilling various functions such as system monitoring and operation, process and system optimization, fault diagnosis, event prediction, and simulation of the elevator system. The DT model uses current real-time information (such as environmental information) of physical entities as input variables, and provides corresponding output variables after analysis and processing. These output variables may be provided or presented to users, or serve as the basis for further fulfilling various functions such as simulation of the DT system. In various embodiments of the present invention, digital twin may be employed to perform simulation analysis on the indication (obtained from media information) of an event that has occurred or is about to occur (e.g., including date, time, and location information of the event), historical data associated with the event, and historical data of elevator operation to generate a command for controlling the operation of one or more elevators in one or more buildings, thereby optimizing the elevator scheduling scheme.

In various embodiments of the invention, it is proposed to utilize media information to sense conditions in the vicinity of an elevator or building to maintain or improve elevator user experience, reduce elevator energy consumption, or lower elevator maintenance costs.

An exemplary flow regarding elevator operation control will be described below.

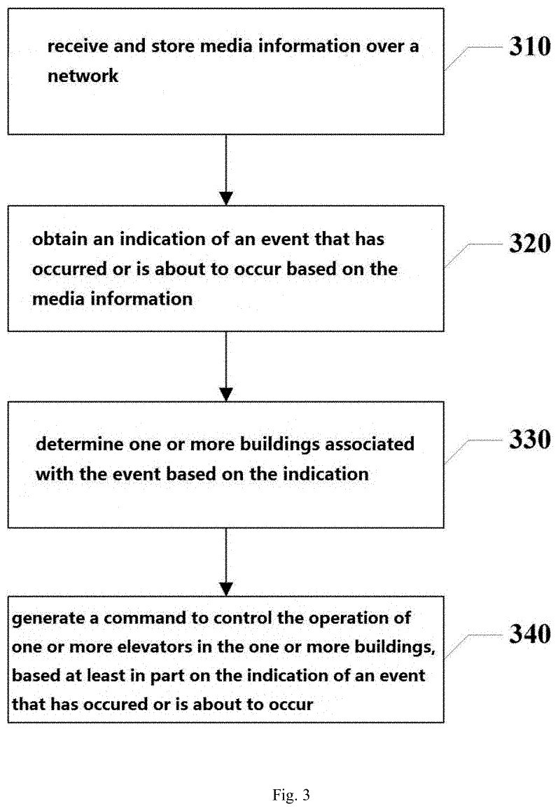

FIG. 3 is a flow chart showing elevator operation control in accordance with various embodiments of the present invention.

In process 310, media information is received and stored over a network. For example, media information may be received from a social media server over a network and stored. The media information includes, for example, traffic information, activity information, or alarm information.

In process 320, an indication of an event that has occurred or is about to occur is obtained based on the media information. The indication may include the date, time, and location information of the event. In some embodiments, the traffic information may indicate traffic conditions such as subway outage or traffic line congestion. The activity information may indicate the date, time, and location of an activity which is, for example, movie show time, time for holding a conference, and opening hours of exhibition center. The alert information may be, for example, fire alarm information.

In process 330, one or more buildings associated with the event are determined based on the indication. For example, one or more buildings associated with the event are determined based on location information of the event.

In process 340, a command for controlling the operation of one or more elevators in one or more buildings is generated at least partly based on the indication of an event that has occurred or is about to occur. In some embodiments, the command guides car(s) of the one or more elevators to a specific floor. In some embodiments, the command sets the operating state of one or more elevators as: start operation, stop operation, high speed mode, low speed mode, or a mode for serving a specific floor.

In an alternative embodiment, a command for controlling the operation of one or more elevators is generated at least partly based on an indication of an event that has occurred or is about to occur and historical data associated with the event. In one example, historical data associated with the event is used to determine an elevator operation mode to be executed. In one example, historical data associated with the event is used to predict the pedestrian flow incurred by an event that has occurred or is about to occur. One of ordinary skill in the art may understand that predictive algorithms may be used to calculate the effective variation of pedestrian flow.

In an alternative embodiment, a command for controlling the operation of one or more elevators is generated at least partly based on the indication of an event that has occurred or is about to occur and parameters associated with one or more elevators. In one example, parameters associated with the elevator(s) are used to estimate the pedestrian flow incurred by an event that has occurred or is about to occur. One of ordinary skill in the art may understand that predictive algorithms may be used to calculate the effective variation of pedestrian flow.

In other embodiments, crowd movement information affected by the event can be determined based on one or more of an event that has occurred or is about to occur, historical data associated with the event, and parameters associated with the elevator. The crowd movement information is associated with a specific date, time period, and location. In other embodiments, the crowd movement information is used to adjust elevator operation. In some additional embodiments, in Digital Twin, simulations are performed to optimize the elevator scheduling scheme to be executed based on one or more of the event that has occurred or is about to occur, historical data associated with the event, and parameters associated with the elevator(s), as stated above.

In accordance with various embodiments of the present invention, during the operation of the elevator system, when a large crowd is expected to be present, the operation mode is changed to maximize elevator operation performance; when no crowd is expected to be present, the elevator is operated at a lower power or at a lower speed. Thus, some embodiments of the present invention may provide effective elevator service to an expected large crowd.

“Crowd” in the context of the present invention refers to a relatively large number of passengers, for example, about 20 or more passengers traveling in a particular direction. Of course, depending on many factors, it may also refer to fewer than 20 passengers.

In other embodiments, an indication of an event that has occurred or is about to occur is obtained based on media information; one or more buildings associated with the event are determined based on the indication; a crowd arriving at a particular building is predicted based on the date, time, and location information of the event. The operation of one or more elevators in one or more buildings is controlled based on the expected arrival period and scale of the crowd.

The abovementioned various operations are described in turn as a plurality of discrete operations. However, the sequence of description should not be construed as implying that these operations must be in line with said sequence.

An example of a computing device fulfilling the functions associated with computer system 10 in FIG. 1, elevator operation server 20 in FIG. 2, and/or flow chart 300 in FIG. 3 will be described below.

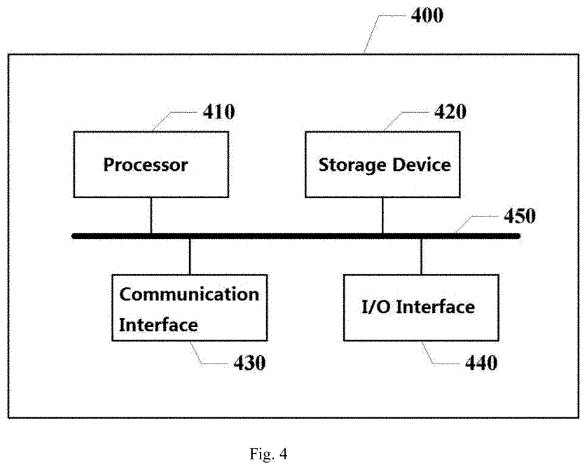

FIG. 4 illustrates an exemplary computing device 400 suitable for use in the present invention in accordance with various embodiments. For example, exemplary computing device 400 may be suitable for and control the method and system of elevator operation.

As illustrated in the figure, computing device 400 may include one or more processors 410, each having one or more processor cores. Processor 410 may include any type of single-core or multi-core processor. Each processor may include a central processing unit (CPU) and one or more levels of caches. Processor 410 may be implemented as an integrated circuit.

Computing device 400 may include storage device 420 which may be any type of temporary and/or permanent storage including, but not limited to, volatile and non-volatile memory, and optical, magnetic, and/or solid state memory. The volatile memory may include, but is not limited to, static and/or dynamic random access memory. The non-volatile memory may include, but is not limited to, erasable programmable read only memory, phase change memory, resistive memory, and the like. In some examples, storage device 420 includes: a magnetic hard disk, a solid state hard drive, a semiconductor storage device, read only memory (ROM), flash memory, or any other computer readable storage medium capable of storing program instructions or digital information. Storage device 420 may store one or more of media information, building location information, operating state information of the elevator(s), historical data associated with the event, parameter information associated with the elevator(s), and the like. Storage device 420 may also store program modules that implement the flow chart shown in FIG. 3 or the method logic in various embodiments of the present invention. The program modules may be a collection of various program instructions. The data information and program information in storage device 420 may serve as computer program products distributed by a computer readable storage medium, or may be received from a distribution server through a communication unit.

Computing device 400 may also include input/output (I/O) device 440, such as a display or a keyboard. Computing device 400 may further include communication unit 430 such as a network interface card, a modem, or a wireless communication transceiver. Communication unit 430 provides communication with other data processing systems or devices, by physical and wireless means. Through communication unit 430, program instructions and data for implementing the embodiments of the present invention may be downloaded to storage device 420. Computing device 400 may have its components coupled to one another via system bus 450.

A plurality of examples are provided as follows in accordance with the embodiments of the present invention.

### Example 1

A computer implemented method for controlling elevator operation, comprising: receiving and storing media information over a network; obtaining an indication of an event that has occurred or is about to occur based on the media information, the indication including the date, time, and location information of the event; determining one or more buildings associated with the event based on the indication; and generating a command for controlling the operation of one or more elevators in the one or more buildings, at least partly based on the indication

### Example 2

The method of Example 1, comprising determining one or more buildings associated with the event based on location information of the event.

### Example 3

The method of Example 2, wherein determining one or more buildings associated with the event based on location information of the event comprises: matching geographic location(s) of one or more buildings with the location of the event to determine one or more buildings associated with the event, taking buildings within a specific range of the location of the event as one or more buildings associated with the event, or determining one or more buildings associated with the event based on the nature of the event.

### Example 4

The method of Example 1, wherein the command guides car(s) of the one or more elevators to a specific floor, or the command sets the operating state of the one or more elevators as one or more of the following: start operation, stop operation, high speed mode, low speed mode, or a mode for serving a specific floor.

### Example 5

The method of Example 1, comprising receiving and storing media information from a social media server over a network, wherein the media information includes traffic information, activity information, or alert information.

### Example 6

The method of Example 5, wherein: in the case of traffic information, the indication includes the date, time and location information of a traffic condition, and the command changes rush hour operation periods of the one or more elevators; in the case of activity information, the activity is one or more of movie show time, time for holding a conference, and opening hours of exhibition center; in the case of alert information, the indication includes the location of the building which gives a fire alarm, and a command for controlling the operation of one or more elevators in buildings adjacent to the building which gives the fire alarm is generated at least partly based on the indication.

### Example 7

The method of Example 1, comprising generating a command for controlling the operation of the one or more elevators at least partly based on the indication and historical data associated with the event, wherein the command is based on a previous operation mode associated with the event or historical data of elevator operation.

### Example 8

The method of Example 1, comprising generating a command for controlling the operation of the one or more elevators at least partly based on the indication and parameters associated with the one or more elevators.

### Example 9

A system for controlling elevator operation, comprising: a computer processor, a computer readable storage medium, and program instructions stored on the computer readable storage medium, the program instructions performing the following steps when executed by the processor: receiving and storing media information over a network; obtaining an indication of an event that has occurred or is about to occur based on the media information, the indication including the date, time, and location information of the event; determining one or more buildings associated with the event based on the indication; and generating a command for controlling the operation of one or more elevators in the one or more buildings, at least partly based on the indication.

### Example 10

The system of Example 9, comprising determining one or more buildings associated with the event based on location information of the event.

### Example 11

The system of Example 10, wherein determining one or more buildings associated with the event based on location information of the event comprises: matching geographic location(s) of one or more buildings with the location of the event to determine one or more buildings associated with the event, taking buildings within a specific range of the location of the event as one or more buildings associated with the event, or determining one or more buildings associated with the event based on the nature of the event.

### Example 12

The system of Example 9, wherein the command guides car(s) of the one or more elevators to a specific floor, or the command sets the operating state of the one or more elevators as one or more of the following: start operation, stop operation, high speed mode, low speed mode, or a mode for serving a specific floor.

### Example 13

The system of Example 9, comprising receiving and storing media information from a social media server over a network, the media information including traffic information, activity information, or alert information.

### Example 14

The system of Example 13, wherein: in the case of traffic information, the indication includes the date, time and location information of a traffic condition, and the command changes rush hour operation periods of the one or more elevators; in the case of activity information, the activity is one or more of movie show time, time for holding a conference, and opening hours of an exhibition center; in the case of alert information, the indication includes the location of the building giving a fire alarm, and a command for controlling the operation of one or more elevators in buildings adjacent to the building giving the fire alarm is generated at least partly based on the indication.

### Example 15

The system of Example 9, comprising generating a command for controlling the operation of the one or more elevators at least partly based on the indication and historical data associated with the event, wherein the command is based on a previous operation mode associated with the event or historical data of elevator operation.

### Example 16

The system of Example 9, comprising generating a command for controlling the operation of the one or more elevators at least partly based on the indication and parameters associated with the one or more elevators.

### Example 17

The method of any one of Examples 1 to 8, comprising using a digital twin system for simulation, at least partly based of the indication, to optimize an elevator scheduling scheme.

### Example 18

The system of any one of Examples 9 to 16, comprising using a digital twin system for simulation, at least partly based of the indication, to optimize an elevator scheduling scheme.

### Example 19

A computer readable storage medium having instructions thereon, wherein the instructions when executed cause a computing device to carry out the method of any one of Examples 1 to 8.

### Example 20

A computing device comprising components for carrying out the method of any one of Examples 1 to 8.

The descriptions of one or more embodiments of the present invention are not intended to be exhaustive or limited to the scope of embodiments in the exact form disclosed or claimed herein. Under the above teachings, modifications and variations are possible, or may be obtained from various implementations of the embodiments. Many modifications and variations will be apparent to one of ordinary skill in the art without departing from the scope and spirit of the present invention.

What is claimed is:

1. A computer implemented method for controlling elevator operation, comprising:
receiving and storing media information over a network;
obtaining an indication of an event that has occurred or is about to occur based on the media information, the indication including date, time, and location information of the event;
determining one or more buildings associated with the event based on the indication; and
generating a command for controlling operations of one or more elevators in the one or more buildings at least partly based on the indication.

2. The method of claim 1, further comprising determining the one or more buildings associated with the event based on the location information of the event.

3. The method of claim 2, wherein determining the one or more buildings associated with the event based on the location information of the event comprises:
matching geographic location of one or more buildings with the location of the event to determine the one or more buildings associated with the event,
taking buildings within a specific range of the location where the event occurs as the one or more buildings associated with the event, or
determining the one or more buildings associated with the event based on the nature of the event.

4. The method of claim 1, wherein the command guides cars of the one or more elevators to a specific floor, or the command sets the operating state of the one or more elevators as one or more of the following: start operation, stop operation, high speed mode, low speed mode, or a mode for serving a specific floor.

5. The method of claim 1, further comprising receiving and storing media information from a social media server over a network, wherein the media information includes traffic information, activity information, or alert information.

6. The method of claim 5, wherein:
in the case of traffic information, the indication includes date, time and location information of a traffic condition, and the command changes rush hour operation periods of the one or more elevators;
in the case of activity information, the activity is one or more of time for showing a movie, time for holding a conference, and opening hours of an exhibition center;
in the case of alert information, the indication includes a location of the building giving a fire alarm, and a command for controlling the operations of one or more elevators in buildings adjacent to the building giving the fire alarm generated at least partly based on the indication.

7. The method of claim 1, further comprising generating a command for controlling the operations of the one or more elevators at least partly based on the indication and historical data associated with the event, wherein the command is based on a previous operation mode associated with the event or historical data of elevator operation.

8. The method of claim 1, further comprising generating a command for controlling the operations of the one or more elevators at least partly based on the indication and parameters associated with the one or more elevators.

9. A system for controlling elevator operation, comprising:
a computer processor,
a computer readable storage medium,
program instruction stored on the computer readable storage medium, the program instruction performs the following steps when executed by the processor:
receiving and storing media information over a network;
obtaining an indication of an event that has occurred or is about to occur based on the media information, the indication including date, time, and location information of the event;
determining one or more buildings associated with the event based on the indication; and
generating a command for controlling the operation of one or more elevators in the one or more buildings at least partly based on the indication.

10. The system of claim 9, wherein the system is configured to determine the one or more buildings associated with the event based on location information of the event.

11. The system of claim 10, wherein determining the one or more buildings associated with the event based on location information of the event comprises:
matching geographic location of one or more buildings with the location of the event to determine the one or more buildings associated with the event,
taking buildings within a specific range of the location where the event occurs as the one or more buildings associated with the event, or
determining the one or more buildings associated with the event based on the nature of the event.

12. The system of claim 9, wherein the command guides cars of the one or more elevators to a specific floor, or the command sets the operating state of the one or more elevators as one or more of the following: start operation, stop operation, high speed mode, low speed mode, or a mode for serving a specific floor.

13. The system of claim 9, wherein the system is configured to receive and store media information from a social media server over a network, the media information including traffic information, activity information, or alert information.

14. The system of claim 13, wherein:
in the case of traffic information, the indication includes date, time and location information of a traffic condition, and the command changes rush hour operation periods of the one or more elevators;
in the case of activity information, the activity is one or more of time for showing a movie, time for holding a conference, and opening hours of an exhibition center;
in the case of alert information, the indication includes a location of the building giving a fire alarm, and a command for controlling the operation of one or more elevators in buildings adjacent to the building giving the fire alarm generated at least partly based on the indication.

15. The system of claim 9, where the system is configured to generate a command for controlling the operation of the one or more elevators at least partly based on the indication and historical data associated with the event, wherein the command is based on a previous operation mode associated with the event or historical data of elevator operation.

16. The system of claim 9, wherein the system is configured to generate a command for controlling the operation of the one or more elevators at least partly based on the indication and parameters associated with the one or more elevators.

17. The method of claim 1, further comprising using a digital twin system to perform simulation at least partly based on the indication so as to optimize an elevator scheduling scheme.

18. The system of claim 9, wherein the system is configured to use a digital twin system to perform simulation at least partly based on the indication, so as to optimize an elevator scheduling scheme.

19. A computer readable storage medium having instructions thereon, wherein the instructions, when executed, cause a computing device to carry out the method of claim 1.

20. A computing device, comprising components for carrying out the method of claim 1.
